(19) United States
(12) Patent Application Publication
(10) Pub. No.: US 2025/0156715 A1
(43) Pub. Date: May 15, 2025

(54) Neural Architecture Search with Improved Computational Efficiency

(71) Applicant: Google LLC, Mountain View, CA (US)

(72) Inventors: Da Huang, Santa Clara, CA (US); Chengrun Yang, Ithaca, NY (US); Pieter-Jan Kindermans, Mountain View, CA (US); Hanxiao Liu, Santa Clara, CA (US); Quoc V. Le, Sunnyvale, CA (US); Madeleine Richards Udell, Ithaca, NY (US); Yifeng Lu, Palo Alto, CA (US); Gabriel Mintzer Bender, Mountain View, CA (US)

(21) Appl. No.: 18/839,379

(22) PCT Filed: Dec. 27, 2022
(86) PCT No.: PCT/US2022/054079

§ 371 Date: Aug. 16, 2024

Related U.S. Application Data
(60) Provisional application No. 63/310,837, filed on Feb. 16, 2022.

(51) Int. Cl. G06N 3/082

(52) U.S. Cl. CPC G06N 3/082

(57) ABSTRACT

Provided are neural architecture search techniques that have improved computational efficiency via performance of an initial constraint evaluation and improved gradient update approach. Further, the proposed approaches provide significant improvements for certain modalities of input data, such as tabular datasets.

### RELATED APPLICATIONS

This application claims priority to and the benefit of U.S. Provisional Patent Application No. 63/310,837, filed Feb. 16, 2022. U.S. Provisional Patent Application No. 63/310,837 is hereby incorporated by reference in its entirety.

### FIELD

The present disclosure relates generally to systems and methods for neural architecture search. More particularly, the present disclosure relates to neural architecture search techniques that have improved computational efficiency via performance of a constraint-based screening and improved gradient update approach. Further, the proposed approaches provide significant improvements for certain modalities of input data, such as tabular datasets.

### BACKGROUND

Artificial neural networks (also referred to simply as “neural networks”) are a class of machine-learned models that are especially powerful, accurate, or otherwise high-performing for various tasks. An artificial neural network can include a group of connected nodes, which can also be referred to as (artificial) neurons or perceptrons. An artificial neural network can be organized into one or more layers. Artificial neural networks that include multiple layers can be referred to as “deep” networks.

Example artificial neural networks include feed-forward neural networks, recurrent neural networks, convolutional neural networks, other forms of artificial neural networks, or combinations thereof. Each of these example types has different internal structures or “architectures” that enable, in part, the particular benefits provided by that type of artificial neural network. For example, the architecture of an artificial neural network can correspond to or include the structure, arrangement, number, types, behavior, operations performed by, and/or other properties of the neurons or layers of neurons included in the network.

More particularly, one developing field of study is that of neural architecture search. Neural architecture search uses the principles and techniques of machine learning to automate or “learn” the design of new artificial neural network architectures. In particular, as examples, neural architecture search (NAS) techniques may seek to automate the specification and discovery of entire neural network topologies, activation functions, gradient update rules, and/or many other complex details that underlie state-of-the-art deep learning architectures. These efforts assume various names in addition to neural architecture search, including “learning to learn,” “AutoML,” “meta-learning,” or the like.

It is often observed that to improve the performance of a machine learning model, one can scale it up. However this is not always possible when machine learning models are deployed since larger networks are also more computationally expensive as measured by inference time, memory usage, energy or processor consumption, etc. These computational costs limit the application of large models: training these models is unsustainable, and inference is often too slow to satisfy end user requirements.

Further, the best neural architecture for a given machine learning problem depends on many factors: not only on resource constraints including latency, compute, energy consumption, etc., but also on the complexity and structure of the dataset. For example, one of the most widespread applications of machine learning in industry is for generation of inferences based on tabular data. However, NAS for tabular datasets is an important but under-explored problem.

Instead, existing NAS approaches have largely been confined to searching for architectures for image processing. For vision tasks, optimizing the models to make them suitable for practical deployment often relies on NAS that targets convolutional networks on vision benchmarks.

While NAS has shown strong outcomes for model architectures for vision processing, direct application of the vision approaches for tabular data is suboptimal. In particular, existing vision-based NAS techniques struggle to find the optimal architectures for tabular datasets. The failure is likely caused at least in part by the interaction of the search space and the reinforcement learning (RL) controller.

In particular, in vision, a popular approach is to use a factorized RL controller, which assumes that all choices can be made independently. The search space consists of a limited number of options per layer. For tabular data, there are typically more options per layer, but there are fewer layers overall. For example, feedforward networks with bottleneck structures often outperform other feed-forward networks of similar size on tabular data. In such a bottleneck architecture, there exists at least one hidden layer that is much narrower than its preceding and following layers. A popular hypothesis is that its weights resemble the low-rank factors of a wider network, and thus mimics the behavior of the latter with less cost. These bottleneck structures often have a very good tradeoff between cost and quality but finding these bottleneck structures is difficult for a factorized RL controller.

To understand why, consider the following toy example with 2 layers. For each layer, the controller can choose a layer size of 2, 3, or 4 and the maximum compute budget is set to 25. The optimal solution is to set the size of layer 1 to 4 and layer 2 to 2. Finding this solution is difficult with a cost penalty. The RL controller is initialized with uniform probabilities. As a result, it is quite likely that the RL controller will initially be penalized heavily when choosing option 4 for the first layer, since two thirds of the choices for the second layer will result in a model that is too expensive. As a result, option 4 for the first layer is quickly discarded by the RL controller and the NAS process gets stuck in a local optimum.

To circumvent this problem, one could attempt to learn a non-factorized probability distribution. However, this requires a more complicated model, e.g., an LSTM, that is often more difficult to tune.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of neural architecture search with increased computational efficiency. The method includes defining, by a computing system comprising one or more computing devices, a plurality of searchable parameters that control an architecture of a neural network, wherein the neural network is configured to process input data to produce inferences. The method includes, for one or more iterations: determining, by the computing system using a controller model, a new set of values for the plurality of searchable parameters to generate a new architecture for the neural network; determining, by the computing system, whether the neural network with the new architecture satisfies one or more constraints; when the neural network with the new architecture does not satisfy the one or more constraints: discarding, by the computing system, the new architecture; and when the neural network with the new architecture satisfies the one or more constraints: determining, by the computing system, one or more performance metrics for the neural network with the new architecture relative to production of inferences for a set of validation data; evaluating, by the computing system, a value function that provides a value based at least in part on the one or more performance metrics and a conditional probability of the new architecture for the neural network given that the new architecture for the neural network satisfies the one or more constraints; and updating, by the computing system, one or more values of one or more parameters of the controller model based on the value function.

Another example aspect of the present disclosure is directed to a computer system that includes one or more processors and one or more non-transitory computer-readable media that collectively store instructions that, when executed by the one or more processors, cause the computing system to perform operations. The operations include determining, by the computing system using a controller model, a new set of values for a plurality of searchable parameters to generate a new architecture for the neural network; determining, by the computing system, one or more performance metrics for the neural network with the new architecture relative to production of inferences for a set of validation data; evaluating, by the computing system, a value function that provides a value based at least in part on the one or more performance metrics and a conditional probability of the new architecture for the neural network given that the new architecture for the neural network satisfies one or more constraints; and updating, by the computing system, one or more values of one or more parameters of the controller model based on the value function.

Another example aspect of the present disclosure is directed to one or more non-transitory computer-readable media that collectively store a neural network having a final architecture identified by performance of operations for a plurality of iterations. The operations include determining, by the computing system using a controller model, a new set of values for a plurality of searchable parameters to generate a new architecture for the neural network; determining, by the computing system, one or more performance metrics for the neural network with the new architecture relative to production of inferences for a set of validation data; evaluating, by the computing system, a value function that provides a value based at least in part on the one or more performance metrics and a conditional probability of the new architecture for the neural network given that the new architecture for the neural network satisfies one or more constraints; and updating, by the computing system, one or more values of one or more parameters of the controller model based on the value function

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

The attached Appendix, which is fully incorporated into and forms a portion of this disclosure, describes example implementations of the systems and methods described herein. The systems and methods of the present disclosure are not limited to the example implementations described in the Appendix.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example neural architecture search according to example embodiments of the present disclosure.

FIG. 1B depicts a block diagram of an example neural architecture search according to example embodiments of the present disclosure.

FIG. 2A depicts a block diagram of an example computing system according to example embodiments of the present disclosure.

FIG. 2B depicts a block diagram of an example computing device according to example embodiments of the present disclosure.

FIG. 2C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to neural architecture search techniques that have improved computational efficiency via performance of an initial constraint evaluation and improved gradient update approach. Further, the proposed approaches provide significant improvements for certain modalities of input data, such as tabular datasets.

In particular, certain existing NAS algorithms designed for image search spaces incorporate resource constraints directly into the reinforcement learning rewards. However, search spaces for tabular NAS pose considerable challenges for these existing reward-shaping methods. Therefore, the present disclosure proposes a new reinforcement learning (RL) controller to address these challenges.

In particular, in some example implementations, when candidate architectures are sampled during a search, example systems described herein can immediately discard any architecture that violates one or more constraints that have been established. Discarding can include flagging, marking, or otherwise treating the architecture as no longer a candidate for providing as a result of the search. According to another example aspect of the present disclosure, some example systems can implement a Monte-Carlo-based correction to the RL policy gradient update to account for this extra filtering step. Results on several tabular datasets show that the proposed approach efficiently finds high-quality models that satisfy the given constraints.

Thus, one example aspect of the present disclosure identifies failure cases of existing resource-aware NAS methods on tabular data and links these cases to the cost penalty in the reward.

Another example aspect of the present disclosure proposes and evaluates an alternative: a rejection mechanism which ensures that the RL controller can only select architectures that satisfy one or more constraints (e.g., user-specified resource constraint(s)). Instead of reward shaping, this extra rejection step allows the RL controller to more immediately explore parts of the search space which would otherwise be overlooked (e.g., due to focusing on a local, but not global optimum).

The rejection mechanism can in some settings introduce a systematic bias into the RL gradient updates, which can skew the search results. To compensate for this bias, the present disclosure also introduces a theoretically motivated and empirically effective correction into the proposed gradient updates. This correction can be computed exactly for small search spaces. When the search space is large, the correction can be efficiently approximated with Monte-Carlo sampling, as described herein.

Example implementations of the present disclosure which implement these aspects can be referred to as TabNAS, a RL-based weight-sharing NAS with the rejection-based reward that can robustly and efficiently find a feasible architecture that has optimal performance within given constraint(s).

The present disclosure provides a number of technical effects and benefits. As one example, the systems and methods of the present disclosure are able to generate new neural architectures much faster and using much fewer computing resources (e.g., less processing power, less memory usage, less power consumption, etc.), for example as compared to naive search techniques which search the entire search space.

As another technical effect and benefit, the systems and methods of the present disclosure are able to generate new neural architectures that are better suited for resource-constrained environments, for example as compared to search techniques which do not contain constraints on the size and/or runtime of the network. That is, the resulting neural architectures are able to be run relatively faster and using relatively fewer computing resources (e.g., less processing power, less memory usage, less power consumption, etc.), all while remaining competitive with or even exceeding the performance (e.g., accuracy) of current state-of-the-art models. Thus, as another example technical effect and benefit, the search technique described herein can automatically find significantly better models than existing approaches and achieve a new state-of-the-art trade-off between performance and runtime/size.

In addition to identifying superior architectures, the proposed systems and methods conserve computational resources by choosing not to explore candidate architectures that do not satisfy constraint(s). In particular, by rejecting candidate architectures that do not meet constraint(s) on the final output architecture prior to completing training and evaluation of such candidate architectures, computational resources that would have been expended training and evaluating the rejected architectures can be conserved. Thus, compared to approaches which simply include constraints in the reward function, the overall expenditure of computational resources can be reduced.

Further, the present disclosure provides a novel approach for automatically learning neural network architectures that are particularly suitable for processing of tabular data sets, which existing vision-focused NAS techniques would fail to discover. Thus, the proposed systems and methods improve the performance of a computer system on tasks associated with processing and/or generating inferences from tabular data. However, although aspects of the present disclosure are described relative to neural networks for processing of tabular data, the architecture search systems and methods described herein are also applicable to search for neural network architectures suitable for performing various other tasks. As an example, the architecture search systems and methods described herein may provide particular benefit in identifying network architectures for any application or domain in which network training and/or inference is particularly computationally demanding.

With reference now to the Figures, example embodiments of the present disclosure will be discussed in further detail.

### Example Notation and Terminology

Math basics. Define [n]={1, . . . , n} for a positive integer n. With a Boolean variable X, the indicator function 1(X) equals 1 if X is true, and 0 otherwise. |S| denotes the cardinality of a set S; stop_grad(f) denotes the constant value (with gradient 0) corresponding to a differentiable quantity f, and can be implemented using tf.stop_gradient(f) in TensorFlow or f.detach( ) in PyTorch. ⊆ and ⊂ denote subset and strict subset, respectively. ∇ denotes the gradient with respect to the variable in the context.

Weight, architecture, and hyperparameter. The term weights refers to the parameters of the neural network and are trained in the neural network training. The architecture of a neural network is the structure of how nodes are connected; examples of architectural choices are hidden layer sizes and activation types. Hyperparameters are the non-architectural parameters that control the training process of either stand-alone training or RL, including learning rate, optimizer type, optimizer parameters, etc.

Neural architecture. A neural network with specified architecture and hyperparameters can be referred to as a model. The number of hidden nodes after each weight matrix and activation function is called a hidden layer size. A single network in the search space can be denoted with hyphen-connected choices. For example, when searching for hidden layer sizes, in the space of 3-hidden-layer ReLU networks, 32-144-24 denotes the candidate where the sizes of the first, second and third hidden layers are 32, 144 and 24, respectively. While example searches described herein are focused on ReLU networks; other activation functions can be used alternatively or additionally.

Loss-resource tradeoff and reference architectures. Within the hidden layer size search space, the validation loss in general decreases with the increase of the number of parameters, giving the loss-resource tradeoff Loss and number of parameters can be understood as two costs for the NAS problem. Thus, there are Pareto-optimal models that achieve the smallest loss among all models with a given bound on the number of parameters. Given a certain architecture that outperforms others with a similar or less number of parameters, example implementations can perform resource-constrained NAS with the number of parameters of this given architecture as the resource target or constraint. This architecture can be referred to as the reference (architecture) of NAS, and its performance the reference performance. NAS can be performed with the goal of matching (the size and performance of) the reference. Note that in some implementations the RL controller only has knowledge of the number of parameters of the reference, and is not informed of its hidden layer sizes.

Search space. When searching L-layer networks, capital letters like X=X₁ . . . X_{L} can be used to denote the random variable of sampled architectures, in which Xᵢ is the random variable for the size of the i-th layer. Lowercase letters like x=x₁ . . . x_{L} can be used to denote an architecture sampled from the distribution over X, in which xᵢ is an instance of the i-th layer size. When there are multiple samples drawn, a bracketed superscript can be used to denote the index over samples: x^{(k)} denotes the k-th sample. The search space S={sᵢⱼ}_{i∈[L],j∈[C}_{ᵢ}_{]} has Cᵢ choices for the i-th hidden layer, in which sᵢⱼ is the j-th choice for the size of the i-th hidden layer: for example, when searching for a one-hidden-layer network with size candidates {5, 10, 15}, we have s₁₃=15.

Reinforcement learning. Example RL algorithms can learn a set of logits { [symbol] ᵢⱼ}_{i∈[L],j∈[C}_{ᵢ}_{]}, in which [symbol] ᵢⱼ is the logit associated with the j-th choice for the i-th hidden layer. With a fully factorized distribution of layer sizes (in which a separate distribution is learned for each layer), the probability of sampling the j-th choice for the i-th layer pᵢⱼ is given by the SoftMax function: pᵢⱼ=exp( [symbol] ᵢⱼ)/Σ_{j∈[C}_{ᵢ}_{]} exp( [symbol] ᵢⱼ). In some example implementations, in each RL step, an architecture y can be sampled to compute the single-step RL objective J(y), and update the logits with ∇J(y): an unbiased estimate of the gradient of the RL value function. Although examples given herein focus on a set of logits as the RL controller model/agent, other, more complex models (e.g., various neural networks such as recurrent neural networks) can be used alternatively to the set of logits as the RL controller.

Resource metric and number of parameters. In some implementations, the number of parameters, which can be easily computed for neural networks, can be used as a cost metric or constraint. Other metrics can be used as well—the systems and methods of the present disclosure do not depend on the specific cost used. Additional example constraints include a runtime latency, a serving latency, a training latency, and/or various other measurable characteristics of an architecture or model.

### Example Neural Architecture Search Techniques

This section provides the details of various example implementations of the present disclosure. These details are provided as examples of how the proposed techniques could be implemented, but the proposed techniques are not limited to these example details. A more general description of the proposed approaches is contained in the following section. However, some of the example systems for NAS described herein can be decomposed into three main components: weight-sharing with layer warmup, REINFORCE with one-shot search, and Monte Carlo (MC) sampling with rejection.

As an overview, some example NAS approaches can begin with a SuperNet, which is a network that layer-wise has width to be the largest choice within the search space. A computer system implementing the NAS process (a “search system”) can first stochastically update the weights of the entire SuperNet to “warm up” over the first 25% of search epochs. Then the search system can alternate between updating the shared model weights (which are used to estimate the quality of different child models) and the RL controller (which focuses the search on the most promising parts of the space).

In some example implementations, in each iteration, the search system can first sample a child network from the current layer-wise probability distributions and update the corresponding weights within the SuperNet (weight update), then sample another child network to update the layerwise logits that give the probability distributions (RL update). The latter RL update is only performed if the sampled network is feasible. In some implementations, when the network is feasible, rejection with Monte-Carlo sampling can be used to update the logits with a sampling probability conditional on the feasible set, as described in more detail elsewhere herein.

To avoid overfitting, some example implementations can split the labelled portion of a dataset into training and validation splits. Weight updates can be carried out on the training split; RL updates can be performed on the validation split.

Example Weight Sharing with Layer Warmup

The weight-sharing approach introduced above has shown success on various computer vision tasks and NAS benchmarks. To do a search for a feedforward network on tabular datasets, some example implementations can build a SuperNet where the size of each hidden layer is the largest value in the search space. When a child network is sampled with a hidden layer size [symbol] ᵢ smaller than the SuperNet, the child network uses only the first [symbol] ᵢ hidden nodes in that layer to compute the output in the forward pass. In weight updates, the weights that are included in the child network can be updated in the backward pass. In updates to the RL controller, the weights of the child network can be used to estimate the quality reward that is used to update the controller (e.g., the logits).

In weight-sharing NAS, warmup helps to ensure that the SuperNet weights are sufficiently trained to properly guide the RL updates. Thus, in some implementations, with probability p, the search system can train all weights of the SuperNet, and with probability 1−p the search system only train the weights of a random child model. When architecture searches are performed for feedforward networks, the search system can do warmup in the first 25% epochs, during which the probability p decays (e.g., linearly) from 1 to 0. The RL controller can be disabled during this period.

Although example implementations are described in which the SuperNet-style weight-sharing approach is used to obtain certain benefits (e.g., reduced training time), the use of weight-sharing is not a required feature of the techniques described herein. The systems and methods of the present disclosure can also be beneficially implemented without the use of weight-sharing. For example, in some implementations, an entirely new set of weights can be learned/trained for each new candidate architecture, or other weight sharing or speedup or pre-training approaches can be used.

### Example One-Shot Training and REINFORCE

Some example implementations can perform NAS for feedforward networks with a REINFORCE-based algorithm. In particular, as an example, when searching for L-layer feedforward networks, an example search system can learn a separate probability distribution over Cᵢ size candidates for each layer. The distribution is given by Cᵢ logits via the SoftMax function. Each layer has its own independent set of logits. With Cᵢ choices for the ith layer, where i=1, 2, . . . , L, there are Π_{i∈[L]} Cᵢ candidate networks in the search space but only Σ_{i∈[L]} Cᵢ logits to learn. This technique significantly reduces the difficulty of RL and make the NAS problem practically tractable.

The REINFORCE-based algorithm can train the SuperNet weights and learn the logits { [symbol] ᵢⱼ}_{i∈[L],j∈[C}_{ᵢ}_{]} that give the sampling probabilities { [symbol] ᵢⱼ}_{i∈[L],j∈[C}_{ᵢ}_{]} over size candidates by alternating between weight and RL updates. In some example implementations, in each iteration, the search system can first sample a child network x from the SuperNet and compute its training loss in the forward pass. Then the search system can update the weights in the child network with gradients of the training loss computed in the backward pass. This weight update step trains the weights of the sampled network. The weights in the architectures with larger sampling probabilities are sampled and thus trained more often. Next, the search system can then update the logits for the RL controller by sampling a child network y that is independent of the network x from the same layerwise distributions, computing the quality reward Q(y) as 1−loss(y) on the validation set, and then updating the controller (e.g., the logits) with the gradient of J(y)=stop_grad(Q(y)−Q̅)logP(y): the product of the advantage of the current network's reward over past rewards (usually an exponential moving average) and the log-probability of the current sample.

The alternation creates a positive feedback loop that trains the weights and updates the logits of the large-probability child networks; thus the layer-wise sampling probabilities gradually converge to more deterministic distributions, under which one or several architectures are finally selected.

Details of a resource-oblivious version are shown as Algorithm 1 below, which does not take into account a resource constraint.

### Algorithm 1: (Resource-Oblivious) One-Shot Training and REINFORCE:

```
Input: search space S, weight learning rate α, RL learning rate η
Output: sampling probabilities {pᵢⱼ}_{i∈[L],j∈[C}_{ᵢ}_{]} [can be replaced with other controller]
initialize logits [symbol] ᵢⱼ ← 0, ∀i ∈ [L], j ∈ [Cᵢ]
initialize quality reward moving average Q̅ ← 0
layer warmup
for iter = 1 to max_iter do
  pᵢⱼ ← exp( [symbol] ᵢⱼ)/Σ_{j∈[C}_{ᵢ}_{]} exp( [symbol] ᵢⱼ), ∀i ∈ [L], j ∈ [Cᵢ]
  weight update:
  for i = 1 to L do
    xᵢ ← the i-th layer size sampled from {sᵢⱼ}_{j∈[C}_{ᵢ}_{]} with distribution {pᵢⱼ}_{j∈[C}_{ᵢ}_{]}
  end for
  loss(x) ← the (training) loss of x = x₁ ... x_{L} on the training set
  w ← w ← α∇loss(x), in which w is the weights of x [can be replaced with optimizers
other than SGD]
  RL update:
  for i = 1 to L do
    yᵢ ← the i-th layer size sampled from {sᵢⱼ}_{j∈[C}_{ᵢ}_{]} with distribution {pᵢⱼ}_{j∈[C}_{ᵢ}_{]}
  end for
  Q(y) ← 1 − loss(y), the quality reward of y = y₁ ... y_{L} on the validation set
  RL reward r(y) ← Q(y) [can be replaced with resource-aware rewards]
  J(y) ← stop_grad(r(y) − Q̅)logP(y) [can be replaced with Algorithm 2 when
resource-constrained] [symbol]
  ᵢⱼ ← [symbol] ᵢⱼ + η∇J(y), ∀i ∈ [L], j ∈ [Cᵢ] [can be replaced with optimizers other than
SGD]
  $\overline{Q} ← \frac{γ * \overline{Q} + ( 1 - γ ) * Q ( y )}{γ * \overline{Q} + 1 - γ} update moving average with γ = 0.9 [ other hyperparameters$
values can be used]
end for
```

However, the present disclosure also provides an algorithm that combines Monte-Carlo sampling with rejection sampling, which serves as a subroutine of Algorithm 1 by replacing the probability in J(y) with a conditional version.

Algorithm 2: Rejection with Monte-Carlo (MC) Sampling

```
Input: number of MC samples N, feasible set V, MC proposal distribution q, quality reward
moving average Q̅, sampled architecture for RL in the current step y = y₁y₂ ... y_{L}, current
layer size distribution over {sᵢⱼ}_{j∈[C}_{ᵢ}_{]} with probability {pᵢⱼ}_{j∈[C}_{ᵢ}_{]}
Output: J(y)
if y is feasible then
  Q(y) = the quality reward of y
  P(y): = Π_{i∈[L]} P(Yᵢ = yᵢ)
  for i = 1 to L do
    {zᵢ^{(k)}}_{k∈[N]} ← N samples of the i-th layer size, sampled from {sᵢⱼ}_{j∈[C}_{ᵢ}_{]} with
distribution {pᵢⱼ}_{j∈[C}_{ᵢ}_{]}
  end for
  pᵢ^{(k)}: = P(Zᵢ = zᵢ^{(k)}, ∀i ∈ [L], k ∈ [N]
  p^{(k)}: = Π_{i∈[L]} pᵢ^{(k)}, ∀k ∈ [N]
  $\hat{P} ( V ) ← \frac{1}{N} {\sum }_{k ∈ [ N ] , {z}^{( k )} ∈ V} \frac{{p}^{( k )}}{{q}^{( k )}} , in which {z}^{( k )} : = {z}_{1}^{( k )} … {z}_{L}^{( k )}$
  $J ( y ) ← stop\_grad ( Q ( y ) - \overline{Q} ) log \frac{P ( y )}{\hat{P} ( V )}$
else
  J(y) ← 0
end if
```

Example Rejection-Based Reward with MC Sampling

Only a subset of the architectures in the search space S will satisfy a set of given resource constraint(s), V denotes this set of feasible architectures. To find a feasible architecture, a resource target T₀ is often used in an RL reward. Given an architecture y, a latency-aware reward combines its quality Q(y) and resource consumption T(y) into a single reward. Certain prior works propose the reward functions Q(y)×(T(y)/T₀)^{β} and Q(y)×max{1, (T(y)/T₀)^{β}} while others propose the absolute value reward (or Abs Reward) Q(y)+β|T(y)/T₀−1|. In these approaches β is a hyperparameter that needs careful tuning. The idea behind these reward functions is to encourage models with high quality with respect the resource target.

However, for Tabular data, RL controllers using these resource-aware rewards above can struggle to discover bottleneck structures—where a large number of filters are selected for the ith layer of the network but a small number of filters are selected for the i+1st layer.

Such a phenomenon reveals a gap between the true distribution the system would optimally sample from and the distributions given by factorized search space that the system is in fact sampling from:

The search system samples only from the set of feasible architectures V, whose distribution is {P(y|y∈V)}_{y∈v}. The number of parameters (or another resource metric) of an architecture, and thus its feasibility, is determined jointly by the sizes of all layers.

On the other hand, the factorized search space determines that a separate (independent) probability distribution is learned for the choices of each layer. While this distribution is efficient to learn, the independence assumption makes it difficult for a RL controller with a resource-aware reward to choose a bottleneck structure. A bottleneck requires the controller to select large sizes for some layers and small layer sizes for others. But decisions for different layers are made independently, and both very large and very small layer sizes, when selected independently of each other, have very negative expected rewards. Small layers are likely to have suboptimal quality, and large layers are likely to exceed the resource constraints.

To bridge the gap and efficiently learn layerwise distributions that take into account the architecture feasibility, a rejection-based RL reward is provided, one example of which is shown in Algorithm 2. An overview of Algorithm 2's main thrust is as follows: REINFORCE optimizes a set of logits { [symbol] ᵢⱼ}_{i∈[L],j∈[C}_{ᵢ}_{]} which define a probability distribution p over architectures. In the original REINFORCE algorithm, a random architecture y is sampled from p and then its quality Q(y) is estimated. Updates to the logits [symbol] ᵢⱼ take the form

$${ℓ}_{i j} ← {ℓ}_{i j} + η \frac{\partial }{\partial {ℓ}_{i j}} J ( y ) ,$$

where ƒ is the learning rate,

$$J ( y ) = stop\_grad ( Q ( y ) - \overline{Q} ) \cdot log ℙ ( y )$$

and Q̅ is a moving average of recent rewards. J(y) can be referred to as a value function. If y is better (resp. worse) than average then Q(y)−Q̅ will be positive (resp. negative), so the REINFORCE update will increase (resp. decrease) the probability of sampling the same architecture in the future.

In the newly proposed REINFORCE variant, motivated by rejection sampling, the REINFORCE update to the logits is skipped unless y is feasible. And if y is feasible, we the probability P(y) in the REINFORCE update equation is replaced with the conditional probability P(y|y∈V)=P(y)/P(y∈V). So J(y) becomes

$$J ( y ) = stop\_grad ( Q ( y ) - \overline{Q} ) \cdot log [ P ( y ) / P ( y ∈ V ) ] .$$

The search system can compute the probability of sampling a feasible architecture P(V):=P(y∈V) exactly when the search space is small, but that becomes prohibitively expensive when the space is large. In the latter case, the search system can replace the exact probability P(y) with a differential approximation P(y) obtained using Monte-Carlo (MC) sampling. In each RL step, the search system can sample N architectures {z^{(k)}}_{k∈[N]} within the search space with a proposal distribution q, and get

$$\hat{P} ( V ) = \frac{1}{N} {\sum }_{k ∈ [ N ]} \frac{{p}^{( k )}}{{q}^{( k )}} \cdot 1 ( {z}^{( k )} ∈ V )$$

as an estimate of P(V). For each k∈[N], p^{(k)} is the probability of sampling z^{(k)} with the factorized layerwise distributions, and is thus differentiable with respect to the logits. In contrast, q^{(k)} is the probability of sampling z^{(k)} with the proposal distribution, and is therefore non-differentiable.

\hat{P}(V) is an unbiased and consistent estimate of P(V), and ∇log[P(y)/\hat{P}(V)] is a consistent estimate of ∇log[P(y|y∈V)]. A larger N gives better result; in some example experiments, less than the size of the sample space was able to achieve a faithful estimate because neighboring RL steps can correct the estimates of each other. In some example implementations, the search system can set q=stop_grad(p) for convenience and use the current distribution over architectures for MC sampling. Other distributions that have a larger support on V may be used to reduce the sampling variance.

At the end of NAS, the search system can pick the layer sizes with largest sampling probabilities as the found architecture if the layerwise distributions are deterministic, or sample the distributions m times and pick n feasible architectures with the largest number of parameters if not. Although it is cheap to use larger values, in some examples m=500 and n≤3 suffice to find an architecture that can match the reference architecture.

In practice, the distributions often (almost) converge after 2× of the number of epochs used to train stand-alone child networks, while the distributions are often informative enough after 1× epochs.

### Algorithm 3: Sample to Return the Final Architecture

Input: sampling probabilities {pᵢⱼ}_{i∈[L],j∈[C}_{ᵢ}_{]} returned by Algorithm 1,
number of desired architectures n, number of samples to draw m
Output: the set of n selected architectures A
for i = 1 to L do
{xᵢ^{(k)}}_{k∈[m]} ← m samples of the i-th layer size, sampled from {sᵢⱼ}_{j∈[C}_{ᵢ}_{]}
with distribution {pᵢⱼ}_{j∈[C}_{ᵢ}_{]}
end for
F: = {k ∈ [m]|x₁^{(k)}x₂^{(k)} ...x_{L}^{(k)} ∈ V}
A ← n unique architectures in F with largest numbers of parameters

### Example Neural Architecture Search

Instead of hand-designing an architecture, aspects of the present disclosure perform an architecture search for automatic design within a huge search space. The search process can explore building networks constrained for both runtime and number of parameters. Further, after finding architectures satisfying those requirements, the resulting networks can optionally be scaled-up to improve performance.

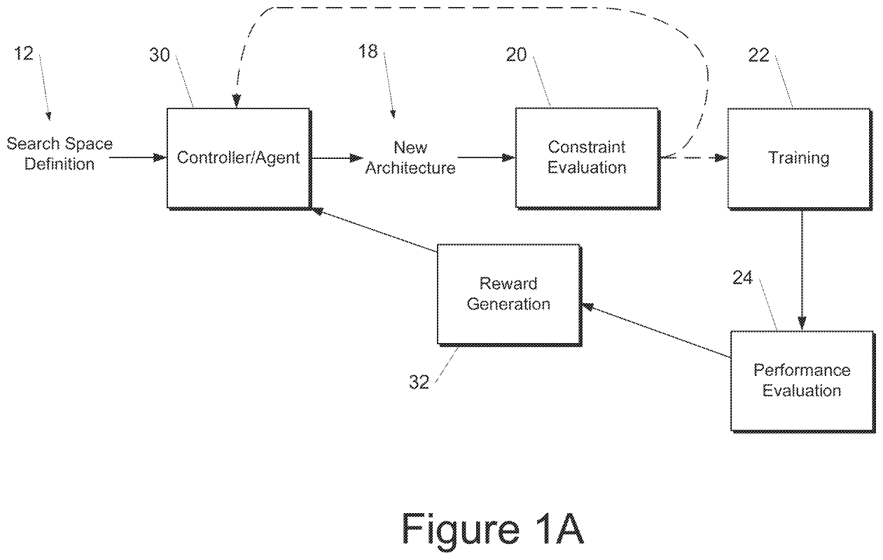

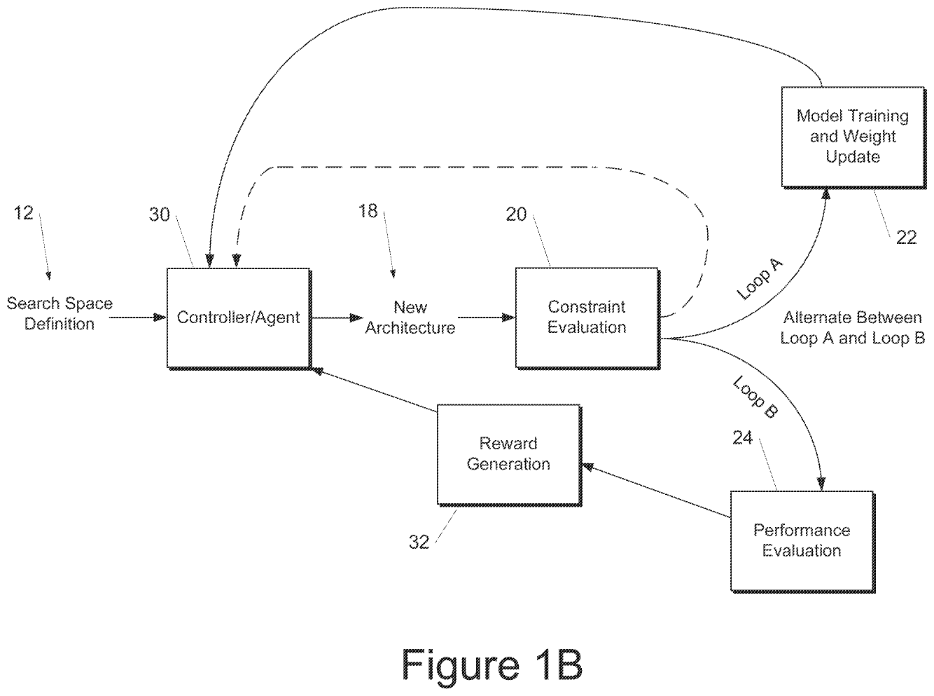

FIG. 1A depicts a graphical diagram of an example reinforcement learning approach to neural architecture search according to example embodiments of the present disclosure.

More particularly, the illustrated neural architecture search can perform an architecture search within a search space 12. The search space 12 can define or contain a number of searchable parameters. Acceptable values or ranges of values can be provided for each searchable parameter. The search process can iteratively search within the search space 12 to identify optimal network architectures within the search space 12.

Having defined the search space 12, the search process can proceed on an iterative basis. In particular, the reinforcement learning process shown in FIG. 1A includes a controller 30 that operates to generate (e.g., select values for) a new architecture 18.

More specifically, in some implementations, the controller 30 can act as an agent in a reinforcement learning scheme to select values for the searchable parameters of the search space 12 to generate the new architecture 18. For example, at each iteration, the controller 30 can apply a policy (e.g., output a prediction (e.g., a probabilistic prediction) on the basis of its learned parameter values) to select the values for the searchable parameters to generate the new architecture 18. As one example, the controller 30 can be a recurrent neural network. As another example, the controller 30 can include a plurality of sets of logits that are respectively associated with the plurality of searchable parameters. For example, each of the plurality of sets of logits generates its respective prediction independent of the other sets of logits.

Referring again to FIG. 1A, in some implementations and according to an aspect of the present disclosure, prior to training 22 and/or performance evaluation 24 of the new architecture 18, the search process can first perform a constraint evaluation process 20 that determines whether the new architecture 18 satisfies one or more constraints. For example, the constraints evaluated at 20 can include constraints on the number of parameters, storage space required by the model, model runtime, training latency, serving latency, interoperability to certain hardware accelerators, parallelizability, etc.

In some implementations, some or all of the constraint(s) can be evaluated prior to any training 22 and/or evaluation 24 of the new architecture 18. For example, a constraint on a number of parameters can easily be evaluated by simply analyzing the number of parameters included in the architecture 18. In some implementations, some or all of the constraints can be evaluated at the beginning or during training 22 and/or evaluation 24. For example, a constraint on the runtime of the new architecture 18 may require some number of initial forward passes using the network to evaluate the runtime of the network. In other implementations, the runtime of the network can be estimated (e.g., without performing any forward passes through the network) and the runtime constraint can be evaluated based on such estimation.

As described elsewhere herein, if the new architecture 18 does not satisfy the constraint(s), then it can be discarded (e.g., with little to no time spent on training 22 and/or evaluation 24). For example, if the new architecture 18 is discarded, then the search process can return to the candidate generation stage and generate another new architecture. For example, the controller 30 can generate another new architecture. Discarding can include flagging, marking, or otherwise treating the new architecture 18 as no longer a candidate for providing as a result of the search. Once discarded, the new architecture 18 may be deleted or optionally retained in memory (e.g., as an artefact of the search).

However, if the new architecture 18 does satisfy the constraint(s), then it can be trained 22 on a set of training data and then evaluated 24 on a set of evaluation data (e.g., validation data). In some implementations in which weight sharing is used (as described above), training 22 may not be necessary or performed. Alternatively, training 22 may be performed on a first candidate architecture to update shared weights while the evaluation 24 can be performed on a second, different candidate architecture after the shared weights have been updated.

In particular, FIG. 1A shows an approach in which each candidate architecture is both trained and evaluated. However, other implementations of the present disclosure alternate between training a candidate architecture (e.g., a model that includes shared weights, where training is performed to update the shared weights) and evaluating a performance of a candidate architecture (e.g., where evaluation is performed to update the controller 30). This arrangement is described in certain sections above and also shown in FIG. 1B. Further, while FIG. 1B shows constraint evaluation occurring during a training loop, this is not required. Some implementations may perform a training loop (e.g., loop A) even if the candidate architecture does not meet the constraints (e.g., constraints may not even be evaluated).

Referring again to FIG. 1A, evaluation 24 can include assessing one or more performance metrics (e.g., a fitness function [symbol] ) for a trained model having the new architecture 18. For example, the fitness function can be various forms of loss functions and/or performance metrics (e.g., accuracy, recall, area under curve, resource-aware losses, etc.)

After evaluating 24 the performance of the new architecture 18, the search system can use the performance metric(s) measured at evaluation 24 to determine a reward 32 to provide to the controller 30 in a reinforcement learning scheme. For example, the reward can be correlated to the performance of the architecture 18 (e.g., a better performance results in a larger reward and vice versa).

In particular, determining the reward 32 can include evaluating, by the computing system, a value function that provides a value based at least in part on the one or more performance metrics and a conditional probability of the new architecture 18 for the neural network given that the new architecture for the neural network satisfies the one or more constraints.

In some implementations, the conditional probability can be an exact conditional probability. In other implementations, the conditional probability comprises an estimated conditional probability. For example, evaluating, by the computing system, the value function can include performing, by the computing system, a Monte-Carlo sampling technique to determine the estimated conditional probability. One example of this approach is described in Algorithm 2, given above.

At each iteration, the policy of the controller 30 can be updated based on the reward 32. In particular, the search system can update one or more values of one or more parameters of the controller model based on the value function described above.

As such, the controller 30 can learn (e.g., through update of its policy based on the reward 32) to produce architectures 18 that provide strong performance. In some implementations, if the architecture 18 fails the constraint evaluation 20, the controller 30 can be provided with zero reward, negative reward, or a relatively low reward.

The search process can continue for a number of rounds (e.g., approximately 1000 rounds). Alternatively, the search process can continue until certain performance thresholds are met.

### Example Devices and Systems

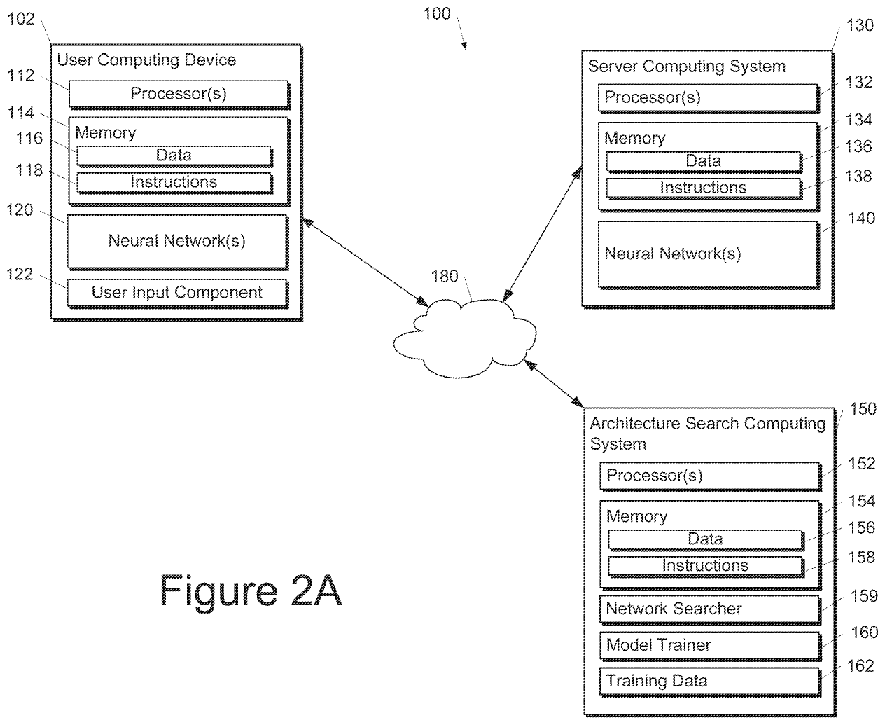

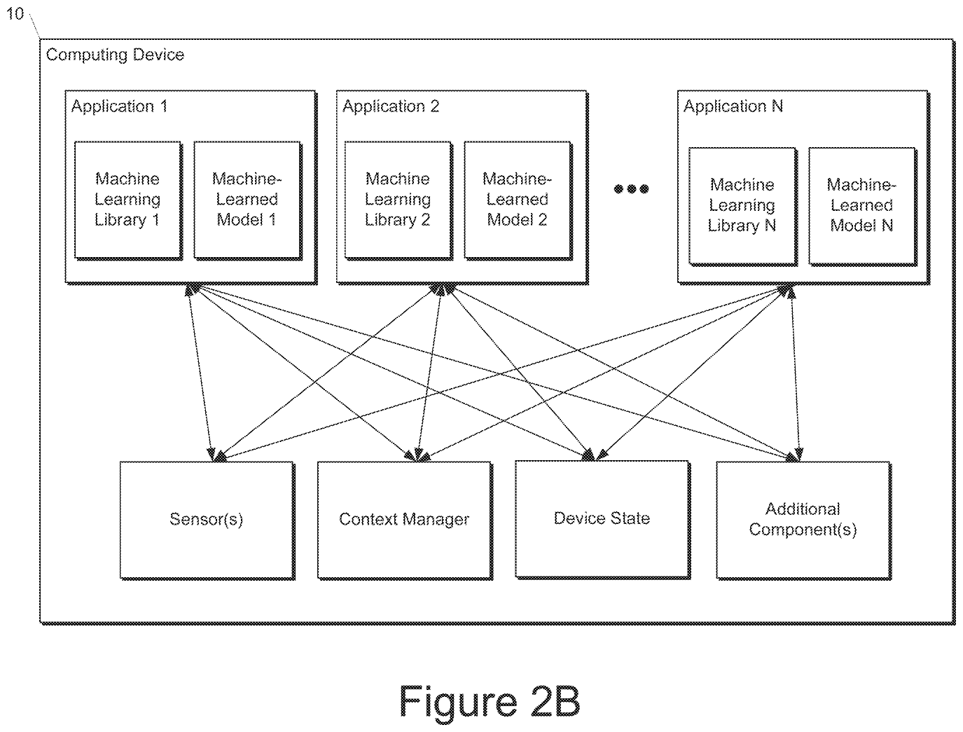

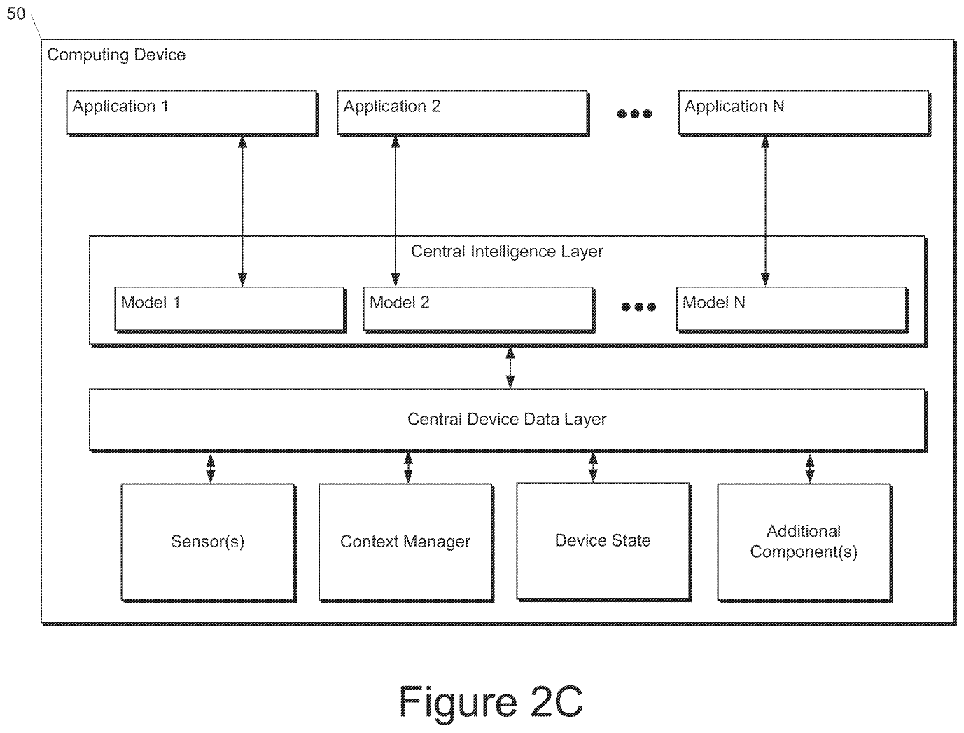

FIG. 2A depicts a block diagram of an example computing system 100 according to example embodiments of the present disclosure. The system 100 includes a user computing device 102, a server computing system 130, and an architecture search computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more neural networks 120. For example, the neural networks 120 can be or can otherwise include various machine-learned models such feed-forward neural networks, recurrent neural networks (e.g., long short-term memory recurrent neural networks), convolutional neural networks or other forms of neural networks.

In some implementations, the one or more neural networks 120 can be received from the server computing system 130 over network 180, stored in the user computing device memory 114, and then used or otherwise implemented by the one or more processors 112. In some implementations, the user computing device 102 can implement multiple parallel instances of a single neural network 120

Additionally or alternatively, one or more neural networks 140 can be included in or otherwise stored and implemented by the server computing system 130 that communicates with the user computing device 102 according to a client-server relationship. For example, the neural networks 140 can be implemented by the server computing system 140 as a portion of a web service. Thus, one or more networks 120 can be stored and implemented at the user computing device 102 and/or one or more networks 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned neural networks 140. For example, the neural networks 140 can be or can otherwise include feed forward neural networks, deep neural networks, recurrent neural networks, and convolutional neural networks.

The user computing device 102 and/or the server computing system 130 can train and/or evaluate the networks 120 and/or 140 via interaction with the architecture search computing system 150 that is communicatively coupled over the network 180. The architecture search computing system 150 can be separate from the server computing system 130 or can be a portion of the server computing system 130.

The architecture search computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the architecture search computing system 150 to perform operations. In some implementations, the architecture search computing system 150 includes or is otherwise implemented by one or more server computing devices.

The architecture search computing system 150 can include a model trainer 160 that trains and/or evaluates the machine-learned networks 120 and/or 140 stored at the user computing device 102 and/or the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the neural networks 120 and/or 140 based on a set of training data 162. In some implementations, if the user has provided consent, the training examples can be provided by the user computing device 102. Thus, in such implementations, the network 120 provided to the user computing device 102 can be trained by the architecture search computing system 150 on user-specific data received from the user computing device 102. In some instances, this process can be referred to as personalizing the model.

The architecture search computing system 150 can also include a network searcher 159. The network searcher 159 can have the components and framework described herein, such as, for example, as illustrated in FIG. 1A. Thus, for example, the network searcher 159 can include a controller (e.g., an RNN-based controller) and/or a reward generator. The network searcher 159 can cooperate with the model trainer 160 to train the controller and/or generated architectures. The architecture search computing system 150 can also optionally be communicatively coupled with various other devices (not specifically shown) that measure performance parameters of the generated networks (e.g., mobile phone replicas which replicate mobile phone performance of the networks to evaluate hardware-specific runtimes).

Each of the model trainer 160 and the network searcher 159 can include computer logic utilized to provide desired functionality. Each of the model trainer 160 and the network searcher 159 can be implemented in hardware, firmware, and/or software controlling a general purpose processor. For example, in some implementations, each of the model trainer 160 and the network searcher 159 can include program files stored on a storage device, loaded into a memory and executed by one or more processors. In other implementations, each of the model trainer 160 and the network searcher 159 can include one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 2A illustrates one example computing system that can be used to implement the present disclosure. Other computing systems can be used as well. For example, in some implementations, the user computing device 102 can include the model trainer 160 and the training dataset 162. In such implementations, the networks 120 can be both trained and used locally at the user computing device 102. In some of such implementations, the user computing device 102 can implement the model trainer 160 to personalize the networks 120 based on user-specific data.

Further, although the present disclosure is described with particular reference to neural networks. The systems and methods described herein can be applied to other multi-layer machine-learned model architectures.

FIG. 2B depicts a block diagram of an example computing device 10 according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method of neural architecture search with increased computational efficiency, the method comprising:
defining, by a computing system comprising one or more computing devices, a plurality of searchable parameters that control an architecture of a neural network, wherein the neural network is configured to process input data to produce inferences; and
for one or more iterations:
determining, by the computing system using a controller model, a new set of values for the plurality of searchable parameters to generate a new architecture for the neural network;
determining, by the computing system, whether the neural network with the new architecture satisfies one or more constraints;
when the neural network with the new architecture does not satisfy the one or more constraints: discarding, by the computing system, the new architecture; and
when the neural network with the new architecture satisfies the one or more constraints:
determining, by the computing system, one or more performance metrics for the neural network with the new architecture relative to production of inferences for a set of validation data;
evaluating, by the computing system, a value function that provides a value based at least in part on the one or more performance metrics and a conditional probability of the new architecture for the neural network given that the new architecture for the neural network satisfies the one or more constraints; and
updating, by the computing system, one or more values of one or more parameters of the controller model based on the value function.

2. The computer-implemented method of claim 1, wherein the conditional probability comprises an exact conditional probability.

3. The computer-implemented method of claim 1, wherein the conditional probability comprises an estimated conditional probability.

4. The computer-implemented method of claim 3, wherein evaluating, by the computing system, the value function comprises performing, by the computing system, a Monte-Carlo sampling technique to determine the estimated conditional probability.

5. The computer-implemented method of claim 1, wherein:
the one or more constraints comprise a size constraint that requires that a number of parameters included in the new network architecture does not exceed a threshold number of parameters.

6. The computer-implemented method of claim 1, wherein:
the one or more constraints comprise a training latency constraint that requires that training of neural network with the new architecture does not exceed a threshold training time.

7. The computer-implemented method of claim 1, wherein:
the one or more constraints comprise a runtime latency constraint that requires that ta runtime latency of neural network with the new architecture does not exceed a threshold runtime.

8. The computer-implemented method of claim 1, wherein the validation data comprises tabular data.

9. The computer-implemented method of claim 1, wherein discarding, by the computing system, the new architecture comprises discarding, by the computing system, the new architecture prior to completion of training of a neural network having the new architecture.

10. The computer-implemented method of claim 1, wherein the controller model comprises a plurality of sets of logits that are respectively associated with the plurality of searchable parameters, and wherein each of the plurality of sets of logits generates its respective prediction independent of the other sets of logits.

11. A computer system, comprising:
one or more processors; and
one or more non-transitory computer-readable media that collectively store instructions that, when executed by the one or more processors, cause the computing system to perform operations, the operations comprising:
determining, by the computing system using a controller model, a new set of values for a plurality of searchable parameters to generate a new architecture for the neural network;
determining, by the computing system, one or more performance metrics for the neural network with the new architecture relative to production of inferences for a set of validation data;
evaluating, by the computing system, a value function that provides a value based at least in part on the one or more performance metrics and a conditional probability of the new architecture for the neural network given that the new architecture for the neural network satisfies one or more constraints; and
updating, by the computing system, one or more values of one or more parameters of the controller model based on the value function.

12. The computer system of claim 11, wherein the conditional probability comprises an exact conditional probability.

13. The computer system of claim 11, wherein the conditional probability comprises an estimated conditional probability.

14. The computer system of claim 13, wherein evaluating, by the computing system, the value function comprises performing, by the computing system, a Monte-Carlo sampling technique to determine the estimated conditional probability.

15. The computer system of any of claim 11, wherein:
the one or more constraints comprise a size constraint that requires that a number of parameters included in the new network architecture does not exceed a threshold number of parameters.

16. The computer system of any of claim 11, wherein:
the one or more constraints comprise a training latency constraint that requires that training of neural network with the new architecture does not exceed a threshold training time.

17. The computer system of any of claim 11, wherein:
the one or more constraints comprise a runtime latency constraint that requires that ta runtime latency of neural network with the new architecture does not exceed a threshold runtime.

18. The computer system of any of claim 11, wherein the validation data comprise tabular data.

19. One or more non-transitory computer-readable media that collectively store a neural network having a final architecture identified by performance of operations for a plurality of iterations, the operations comprising:
determining, by the computing system using a controller model, a new set of values for a plurality of searchable parameters to generate a new architecture for the neural network;
determining, by the computing system, one or more performance metrics for the neural network with the new architecture relative to production of inferences for a set of validation data;
evaluating, by the computing system, a value function that provides a value based at least in part on the one or more performance metrics and a conditional probability of the new architecture for the neural network given that the new architecture for the neural network satisfies one or more constraints; and
updating, by the computing system, one or more values of one or more parameters of the controller model based on the value function.

20. The one or more non-transitory computer-readable media of claim 19, wherein the training data and the validation data comprise tabular data.
